(19) United States
(12) Patent Application Publication
(10) Pub. No.: US 2007/0185301 A1
(43) Pub. Date: Aug. 9, 2007

(54) Moisture cure adhesive for bonding structural wood

(76) Inventors: Albert M. Giorgini, Lino Lakes, MN (US); Benjamin E. Burrows, St. Louis Park, MN (US)

Correspondence Address: H.B. FULLER COMPANY, 1200 WILLOW LAKE BLVD., P.O. BOX 64683, ST. PAUL, MN, 55164-0683, US

(21) Appl. No.: 11/348,699

(22) Filed: Feb. 7, 2006

(51) Int. Cl. C08G 18/00

(52) U.S. Cl. 528/44

(57) ABSTRACT

The invention is directed to a moisture cure adhesive composition for bonding structural wood substrates. The composition includes a moisture curable isocyanate terminated polyurethane prepolymer that is a reaction product of an aliphatic polyol component, an aromatic polyol component, and an aromatic isocyanate component. The composition exhibits an extremely high heat resistance at 180° C.

### FIELD OF THE INVENTION

The invention is directed to a moisture cure adhesive composition for bonding structural wood. In particular, the invention is directed to a one-component moisture cure adhesive composition that includes an isocyanate-terminated polyurethane prepolymer.

### BACKGROUND OF THE INVENTION

One-component and two-component polyurethane (PUR) adhesives have been used for bonding wood for many years. However, these adhesives are generally not suitable for applications that require high structural bond strength at elevated temperatures, e.g., a temperature of greater than about 100° C. Many PUR adhesive formulations may only suitable for applications at a temperature of up to about 80° C. Above these temperatures conventional PUR adhesives show a rapid loss of bond strength or a significant decrease in modulus. Such a reduction in physical and mechanical properties typically shows up as a noticeable creep in the bond line of a bonding product under load conditions. The loss of the bond strength as a noticeable creep under load has prevented the conventional PUR adhesives from bonding structural wood products such as fingerjointed structural studs and structural laminate beams.

A one-component moisture cure adhesive exhibiting high heat resistance, water resistance and good adhesion to bond structural wood would benefit the needs of the construction industry.

### SUMMARY OF THE INVENTION

In one aspect, the invention features a one-component moisture cure polyurethane adhesive composition that includes a moisture curable polyurethane prepolymer. The prepolymer is a reaction product of an aliphatic polyol component, an aromatic polyol component, and an aromatic isocyanate component. The composition has a total isocyanate content of no less than about 5% by weight based on the total weight of the composition.

In some embodiments, the composition has a total isocyanate content of no less than about 7% by weight based on the total weight of the composition. In other embodiments, the composition has a total isocyanate content of no less than about 10% by weight based on the total weight of the composition. In one embodiment, the composition has a total isocyanate content of no less than about 14% by weight based on the total weight of the composition.

In another aspect, the invention features a one-component moisture cure polyurethane adhesive composition that includes a moisture curable polyurethane prepolymer. The prepolymer is a reaction product of an aliphatic polyol component, an aromatic polyol component, and an aromatic isocyanate component. The composition has a viscosity of no greater than about 100,000 cps at 77° F.

In some embodiments, the composition has a viscosity of no greater than about 70,000 cps, or no greater than about 50,000 cps, or no greater than about 20,000 cps, or at least about 1,000 cps at 77° F.

The composition exhibits very high heat resistance as measured by resistance to creep under load at 180° C according to the NLGA SPS-5 Annex A test method.

The composition exhibits block shear strength of at least 10 mPa. according to the NLGA SPS Annex A test method.

In another aspect, the invention features a process for bonding two substrates together including applying the moisture cure adhesive composition of the invention on at least one surface of a first substrate, and contacting the adhesive bearing surface of the first substrate with a second substrate to form a laminate.

In yet another aspect, the invention features an article including a first substrate, a second substrate and the adhesive composition of the invention sandwiched between the first substrate and the second substrate.

In some embodiments, the first and the second substrates are wood such as natural soft wood or hard wood, e.g., pine, fir, maple, oak, aspens, ash, etc., or synthetic wood, or wood/plastic composites.

The article includes such as structural beam, laminated veneer lumber (LVL), I-joint, finger-joint studs, and plywood.

The adhesive composition of the invention contains a very low content of volatile organic component(s), e.g., no greater than about 100 g/l, associated with the use of any organic solvent(s).

### DETAILED DESCRIPTION OF THE INVENTION

The moisture cure adhesive composition includes an isocyanate terminated prepolymer, and optionally, an antioxidant. The isocyanate-terminated prepolymer is a reaction product of at least one aliphatic polyol component, at least one aromatic polyol component and at least one aromatic isocyanate component. “Polyol” as used herein includes those that have two or more hydroxyl functionalities such as diols and triols.

Useful aliphatic polyol component includes those that do not contain an aromatic ring in the main molecular chain, such as polyester polyols, polyether polyols, polyalkylene polyols, and mixtures thereof. Examples of useful aliphatic polyols include those having from 2 to 15 carbon atoms such as ethylene, propylene, tetramethylene, isobutylene, pentamethylene, 2,2-dimethyltrimethylene, hexamethylene, and decamethylene glycols, dihydroxycyclohexane, cyclohexane dimethanol, and the like. In some embodiments, the aliphatic diols and/or triols have from 2 to 6 carbon atoms.

Examples of useful polyether polyols include the poly(alkylene oxide) glycols wherein alkylene has 2 to 6 carbon atoms, such as poly(1,2- and 1,3-propylene oxide) glycol, poly(tetramethylene oxide) glycol, poly(pentamethylene oxide) glycol, poly(hexamethylene oxide) glycol and poly (1,2-butylene oxide) glycol; random or block copolymers of ethylene oxide and 1,2-propylene oxide (used in proportions such that the carbon to oxygen mole ratio in the glycol exceeds 2.5:1) and poly-formals prepared by reacting formaldehyde with glycols such as pentamethylene glycol, or mixtures of glycols, such as a mixture of tetramethylene and pentamethylene glycols.

In some embodiments, the polyether polyols include a polyoxyalkylene polyol having from 2 to 6 carbon atoms in the alkylene group. In one embodiment, the polyoxyalkylene polyols include polytetramethylene ether glycol (PTMEG).

Examples of other useful aliphatic polyols include thiol functional polymers and oligomers such as polyethers, polyesters, polyether urethanes, and polythioethers; hydroxy-terminated polybutadiene; hydroxy-terminated acrylic polyols; and amine-terminated polyethers; castor oil, and mixtures thereof.

Examples of commercially available aliphatic polyols include Polymeg 1000 from BASF (Wyandotte, Mich.).

Useful aromatic polyol component includes polyols that have at least two hydroxyl functionalities and at least one aromatic ring in the molecular chain. The aromatic polyols may have a weight average molecular weight of no greater than about 2,000 g/mole, or no greater than about 1,000 g/mole, or no less than about 100 g/mole. Examples of aromatic polyols include such as resorcinol, hydroquinone, 1,5-dihydroxynapthalene, hydroxymethyl ether resorcinol, hydroxyethyl ether resorcinol, aromatic polyesters based on ortho phthalate from Stepan Company (Northfield, Ill.), and mixtures thereof. Other examples of the aromatic polyols include such as bis(p-hydroxydiphenyl), bis(p-hydroxyphenyl) methane, bis(p-hydroxyphenyl) methane, bis(p-hydroxyphenyl) propane, 2,2-bis(p-hydroxyphenyl) propane, and mixtures thereof.

Examples of commercially available aromatic polyols include HER TG 250 from INSPEC (Pittsburgh, Pa.).

Useful aromatic isocyanate component includes those that have at least one aromatic ring in the main molecular chain and have about two or more isocyanate functionalities. Examples of useful aromatic isocyanates include those that have a weight average molecular weight of no greater than about 1,000 g/mole, or no less than about 160 g/mole, such as diphenyl methane diisocyanate (MDI), toluene diisocyanate (TDI) and p-phenylenediisocyanate (PPDI), naphthalene diisocyanate, dimer diisocyanate and all polymeric, trimeric isocyanates. In some embodiments, the aromatic isocyanates include diphenyl methane diisocyanate (MDI), tetramethylxylene diisocyanate, toluene diisocyanate (TDI), or mixtures thereof.

Examples of commercially available aromatic isocyanates include PAPI 2094 from Dow Chemical Company (Midland, Mich.).

The isocyanate terminated prepolymer has a weight average molecular weight of no less than about 1,000 g/mole, or no greater than about 50,000 g/mole, or no greater than about 20,000 g/mole, or even no greater than about 10,000 g/mole.

The isocyanate-terminated prepolymer has a viscosity of no greater than about 100,000 cps, or no greater than about 60,000 cps, or no greater than about 30,000 cps, or no greater than about 15,000 cps, or even no greater than about 10,000 cps at 77° F.

The isocyanate-terminated prepolymer has a relatively high free isocyanate content. Free isocyanate content refers to the isocyanate groups on the free isocyanate monomers, which are the isocyanate monomers that did not participate in the formation of the prepolymer. Free isocyanate content is based on the total isocyanate content in the adhesive composition. In some embodiments, the free isocyanate content in the prepolymer is greater than about 10% by weight, or greater than about 20% by weight. In one embodiment, the isocyanate-terminated prepolymer has about 40% by weight of the free isocyanate content.

Useful antioxidants include phenolics, phosphates, thioesters, and hindered amines.

Examples of commercially available antioxidants include Cyanox 1790, Cyanox LTDP, from Cytec Industries (West Peterson, N.J.); Irganox 1010 from Ciba Specialty chemical Inc. (Tarrytown, N.Y.); BNX 1010, 1076, DLTDP from Mayzo(Noscross Ga.); Anox from Great lakes Chemical (West Lafayette, Ind.). Antioxidant may be present in the adhesive composition in an amount of from about 0.05% by weight to about 1% by weight, based on the total weight of the composition.

The moisture cure adhesive composition of the invention is in liquid form at ambient temperatures. It is also substantially solvent(s) free. That is, the composition does not contain any substantial amount, e.g., greater than about 5% by weight, or greater than about 2% by weight based on the total weight of the composition, of any organic solvent(s).

The adhesive composition has a viscosity of no greater than about 100,000 cps, or no greater than about 70,000 cps, or no greater than about 50,000 cps, or no greater than about 20,000 cps, or no less than about 1,000 cps, or no less than about 2,000 cps at 77° F.

The adhesive composition has a total isocyanate content (% NCO) of greater than about 5% by weight, or no less than about 7% by weight, or no less than about 10% by weight, or even no less than about 14% by weight, based on the total weight of the adhesive composition. Total isocyanate content refers to all the isocyanate groups in the adhesive composition, which includes the free isocyanate content and the isocyanate content on the prepolymer.

The adhesive composition may also include at least one catalyst to accelerate the curing speed without adversely affecting any other properties of bonded wood products. Examples of useful catalysts include those that contain ether and morpholine functional groups, e.g., 2,2-dimorpholinoethyl ether and di(2,6-dimethyl morpholinoethyl)ether; 4,4′-(oxydi-2,1-ethanediyl)bis-morpholine; tertiary amine; organo tin, zinc and bismuth catalysts such as dibutyl tin dilaurate, dibutyl tin diacetate and bismuth octoate, and mixtures thereof. Commercially available catalysts include 4,4′-(oxydi-2,1-ethanedyl) bis-morpholine know as Jeffcat™ DMDEE from Huntsman Corp. (Houston, Tex.), Dabco BL-19, Dabco T-9 and Dabco T-12 from Air Products, (Allentown, Pa.), and Coscat 83 from Caschem (Bayonne, N.J.). The catalyst may be present in an amount of no greater than about 2 wt %, or no greater than about 1.5 wt %, or no less than about 0.05 wt %, based on the total weight of the composition.

The adhesive composition may also include other optional ingredients such as pigments, fillers, plasticizers or diluents, defoamers, etc. and combination thereof.

The adhesive composition can be prepared by conventional processes known in the art. For example, the compositions can be prepared by first preparing isocyanate-terminated polyurethane prepolymer, and then blending the prepolymer with other optional ingredient(s). Alternatively, the adhesive composition can be made by preparing the isocyanate-terminated polyurethane prepolymer together with any other optional ingredient(s), such as catalyst(s), antioxident(s), plasticizer(s), etc. Thus, optional ingredient(s) can be added prior to, during, or after the formation of the prepolymer to obtain the adhesive composition.

The isocyanate-terminated polyurethane prepolymer is prepared by reacting the polyol component(s) with the polyisocyanate component at an elevated temperature of from about 77° F. to about 180° F. The polyol component(s) may first be introduced into a reaction vessel, heated to reaction temperature and dried to remove ambient moisture absorbed by the polyol(s). The polyisocyanate component is then added to the reactor. The polyol(s) is generally reacted with the polyisocyanate at a stoichiometric ratio depending on the hydroxy (OH) and isocyanate (NCO) functionality of the reactants. Typically the reactants are reacted at a ratio that the reaction between isocyanate groups and hydroxy groups leaves essentially no residual hydroxy functionality. Typically, the reaction between the polyol(s) and the polyisocyanate is conducted at a NCO/OH ratio of at least about 1.8, or from about 2 to about 20 to obtain the desired prepolymer. The prepolymer is titrated to measure residual concentration of isocyanate using ASTM D-2572-80 “Standard Method for Isocyanate Group and Urethane Materials or Prepolymers” to determine the completion of the reaction.

The adhesive composition can be applied by extrusion, brush, roll coat or spray.

Wood products include, e.g., fingerjointed structure, structural beam, laminated veneer lumber (LVL), I-joint, plywood, or combinations thereof. Suitable wood includes natural wood material, e.g. hard and soft woods.

The adhesive composition can be cured by contacting moisture at various conditions depending on the specific formulations. The adhesive composition can be cured at ambient conditions, e.g., ambient temperature and ambient relative humidity. Or, a variety of methods can be used to contact the composition with moisture including, e.g., exposing the composition to ambient moisture; contacting the composition with moisture in the form of a spray, mist, fog or a combination thereof; placing the composition in a chamber with high humidity (e.g., greater than about 50% relative humidity), or the combinations thereof. The composition can be cured at application temperature such as from ambient temperature to about 200° F. depending on the production line. In some embodiments, the composition is curable at ambient conditions after being sandwiched between wood substrates, i.e., there is no need to use heat to cure the composition. The polyurethane adhesive can be cured at ambient conditions, e.g., ambient temperature and ambient relative humidity.

The invention is further illustrated by the following non-limiting examples. All the parts, percentages, ratios, amounts are by weight except otherwise specified.

### EXAMPLES

Testing Methods

Block Shear Strength

Block shear strength of an adhesive composition is tested according to NL®GA (National Lumber Grades Authority) SPS 5-2003 Special Products Standard for Face-Glued Lumber-Vertical Use Only; NLGA SPS ANNEX A Standard Specification for Evaluation of Adhesives for Structural Wood Products (Exterior Exposure). The evaluation is performed on softwood (black spruce pine).

Heat Resistance

Heat resistance of an adhesive composition is tested according to NL®GA (National Lumber Grades Authority) SPS 5-2003 Special Products Standard for Face-Glued Lumber-Vertical Use Only; NLGA SPS ANNEX A Standard Specification for Evaluation of Adhesives for Structural Wood Products (Exterior Exposure). The evaluation is performed on softwood (black spruce pine) at three different environmental conditions. The adhesive composition exhibits heat resistance at 180° C. if it passes the environmental test condition B2.

Delamination Resistance

Delamination resistance of an adhesive composition is tested according to NL®GA (National Lumber Grades Authority) SPS 5-2003 Special Products Standard for Face-Glued Lumber-Vertical Use Only; NLGA SPS ANNEX A Standard Specification for Evaluation of Adhesives for Structural Wood Products (Exterior Exposure). The evaluation is performed on softwood (black spruce pine).

### Examples 1-3 and Comparative Examples A and B

Each of the adhesive compositions in Examples 1-3 and in Comparative Examples A and B is prepared using the ingredients listed in Table I.

The heat resistance of the resultant adhesive compositions of Examples 1 and 2 and Comparative Examples A and B are tested according to the NLGA SPS-5 ANNEX A test method and the results are listed in Table II.

The heat resistance, the block shear strength, and the delamination resistance of the resultant adhesive composition of Example 3 are tested according to the NLGA SPS-5 ANNEX A test methods and the results are listed in Table III.

TABLE I

| | | | | | Com. | Com. |
|---|---|---|---|---|---|---|
| | | Ex. 1 | Ex. 2 | Ex. 3 | Ex. A | Ex. B |
| | | (wt %) | (wt %) | (wt %) | (wt %) | (wt %) |
| Poly-G 20-110 | Aliphatic | | | | 37.515 | |
| | polyol | | | | | |
| Tone 0201 | Aliphatic | | | | | 9.882 |
| | polyol | | | | | |
| Polymeg 1000 | Aliphatic | 36.00 | 35.98 | 31.081 | | 29.606 |
| | polyol | | | | | |
| HER TG 250 | Aromatic | 1.5 | 1.50 | 3.093 | | |
| | polyol | | | | | |
| Papi 2094 | Aromatic | 60.76 | 60.727 | 64.028 | 60.908 | 58.936 |
| | isocyanate | | | | | |
| T-12 | catalyst | 0.111 | 0.11 | 0.111 | 0.110 | 0.110 |
| H3PO4 | stabilizer | 0.002 | 0.002 | 0.002 | 0.002 | 0.002 |
| Foamkill 8D | defoamer | 0.015 | 0.015 | 0.015 | 0.015 | 0.015 |
| DEM | stabilizer | 0.250 | 0.249 | 0.250 | 0.25 | 0.25 |
| DMDEE | catalyst | 1.12 | 1.117 | 1.120 | 1.200 | 1.200 |
| Tinnvin 765 | Free radical | 0.25 | 0.300 | | | |
| | scavenger | | | | | |
| Cyanox LTDP | Free radical | | | 0.25 | | |
| | scavenger | | | | | |
| Cyanox 1790 | Free radical | | | 0.05 | | |
| | scavenger | | | | | |
| Total % NCO | | 15.22 | 15.27 | 15.87 | 15.75 | 14.16 |
| Viscosity (cps) | | 7,500 | 7,000 | 8,100 | 4,500 | 10,500 |
| at 77° F. | | | | | | |

TABLE II

| | SPS-5 Annex A | | | Com. | Com. |
|---|---|---|---|---|---|
| Test Conditions | Requirement | Ex. 1 | Ex. 2 | Ex. A | Ex. B |
| Environment A | <0.25 mm | pass | pass | pass | pass |
| (20° C. for 7 days at | | | | | |
| 90% RH) | | | | | |
| Environment B1 | <0.25 mm | pass | pass | pass | pass |
| (70° C. for 7 days at | | | | | |
| ambient % RH) | | | | | |
| Environment B2 | <0.25 mm | pass | pass | fail | fail |
| (180° C. for 2 hours | | | | | |
| at ambient % RH) | | | | | |

TABLE III

| | SPS | Assembly Time (min/min¹) | | | | | |
|---|---|---|---|---|---|---|---|
| | Annex A | min/min² | min/max³ | max/max⁴ | Status | | |
| Test | Requirement | 0/1 | 0/2 | 0/2 | min/min² | min/max³ | max/max⁴ |
| Block Shear | | | | | | | |
| Strength | | | | | | | |
| Average Shear | >9.5 | 12.6 | 11.0 | 11.0 | Pass | Pass | Pass |
| Strength (mPa) | | | | | | | |
| Average Wood | >75 | 91 | 82.0 | 82.0 | Pass | Pass | Pass |
| Failure (%) | | | | | | | |
| Resistance to | | | | | | | |
| Delamination | | | | | | | |
| (%) | | | | | | | |
| Total Average | <5 | 1.2 | 1.0 | 1.0 | Pass | Pass | Pass |
| Delamination | | | | | | | |
| Maximum | <1 | 0.6 | 0.5 | 0.5 | Pass | Pass | Pass |
| Individual Bond | | | | | | | |
| line Delamination | | | | | | | |
| Heat Resistance | | | | | | | |
| (mm) | | | | | | | |
| 27° C., 7 days, | <0.25 | 0.0 | 0.0 | 0.0 | Pass | Pass | Pass |
| 90% RH | | | | | | | |
| (environment A) | | | | | | | |
| 71° C., 7days | <0.25 | 0.0 | 0.0 | 0.0 | Pass | Pass | Pass |
| ambient % RH | | | | | | | |
| (environment B1) | | | | | | | |
| 180° C., 2 hours, | <0.25 | 0.0 | 0.0 | 0.0 | Pass | Pass | Pass |
| ambient % RH | | | | | | | |
| (environment B2) | | | | | | | |

¹minute/minute;
²minimum/minimum;
³minimum/maximum;
⁴maximum/maximum.

We claim:

1. A moisture cure adhesive composition comprising an isocyanate terminated prepolymer that is a reaction product of
a) an aliphatic polyol component that has at least two hydroxyl groups,
b) an aromatic polyol component that has at least two hydroxyl groups,
c) an aromatic isocyanate component that has at least two isocyanate groups, wherein said composition has a total isocyanate content of no less than about 5% by weight based on the weight of the composition.

2. The composition of claim 1, wherein said aromatic isocyanate component has a weight average molecular weight of no greater than about 1,000 g/mole.

3. The composition of claim 1, wherein said aromatic polyol component comprises resorcinol, hydroxymethyl ether resorcinol, hydroxyethyl ether resorcinol, hydroquinone, 1,5-dihydroxynapthalene, aromatic polyesters based on ortho phthalate, or mixtures thereof.

4. The composition of claim 1, wherein said composition has a total isocyanate content of no less than about 7% by weight based on the weight of said composition.

5. The composition of claim 1, wherein said composition exhibits heat resistance at 180° C. according to NLGA SPS-5 Annex A test method.

6. The composition of claim 1, wherein said composition exhibits a block shear strength of no less than about 10 mPa on soft dry wood.

7. The composition of claim 1, wherein said composition has a viscosity of no greater than about 100,000 cps at 77° F.

8. The composition of claim 1, wherein said composition has a viscosity of from about 1,000 to about 50,000 cps at 77 ° F.

9. The composition of claim 1, wherein said composition further comprises an antioxidant.

10. The composition of claim 9, wherein said composition comprises from about 0.05 wt % to about 1 wt % of said antioxidant.

11. The composition of claim 1, wherein said aliphatic polyol component comprises polyester polyols, polyether polyols, castor oil, caprolactone, and mixtures thereof.

12. The composition of claim 1, wherein said composition further comprises at least one catalyst.

13. The composition of claim 1, wherein said aromatic isocyanate component comprises diphenlymethane diisocyanate (MDI), toluene diisocyanate, or mixtures thereof.

14. A process for bonding substrates together comprising
a) applying the moisture cure adhesive composition of claim 1 on at least one surface of a first substrate,
b) contacting said applied adhesive composition with a second substrate to form a laminate.

15. The process of claim 14, wherein at least one of said first and second substrates comprises natural wood, synthetic wood, or wood/plastic composite.

16. An article comprising a first substrate, a second substrate and the adhesive composition of claim 1 sandwiched between said first and second substrates.

17. The article of claim 16, wherein said article comprises structural beam, laminated veneer lumber (LVL), I-joint, plywood, or finger-jointed stud.

18. A moisture cure adhesive composition comprising an isocyanate terminated prepolymer that is a reaction product of
d) an aliphatic polyol component that has at least two hydroxyl groups,
e) an aromatic polyol component that has at least two hydroxyl groups,
f) an aromatic isocyanate component that has at least two isocyanate groups, wherein said composition has a viscosity of no greater than about 50,000 cps at 77° F.

19. The composition of claim 18, wherein said composition exhibits heat resistance at 180° C. according to NLGA SPS-5 Annex A test method.

20. The composition of claim 18, wherein said aromatic polyol component comprises resorcinol, hydroxymethyl ether resorcinol, hydroxyethyl ether resorcinol, hydroquinone, 1,5-dihydroxynapthalene, aromatic polyesters based on ortho phthalate, or mixtures thereof.
